(19) United States
(12) Patent Application Publication
(10) Pub. No.: US 2026/0301545 A1
(43) Pub. Date: Oct. 1, 2026

(54) CURRENCY PROCESSING METHOD AND CURRENCY PROCESSING METHOD

(71) Applicant: GLORY Ltd., Himeji City (JP)

(72) Inventors: Kenta Asaka, Himeji City (JP); Yoshihiro Kasuya, Himeji City (JP); Herman Susenio, Himeji City (JP); Ayaka Yamauchi, Himeji City (JP); Hideki Morishita, Himeji City (JP)

(73) Assignee: GLORY Ltd., Himeji City (JP)

(21) Appl. No.: 19/089,029

(22) Filed: Mar. 25, 2025

(51) Int. Cl. G07F 19/00

(52) U.S. Cl. CPC G07F 19/206; G07F 19/211

(57) ABSTRACT

A currency processing system and a currency processing method are provided. The currency processing system includes a plurality of currency processing devices which operate by selecting one of a normal mode and an emergency mode for responding to an emergency event as an operation mode, and a management device which manages the operation modes of the plurality of currency processing devices and information of a store where the plurality of currency processing devices are installed, in which, in response to the operation mode of at least one of the plurality of currency processing devices having transitioned to the emergency mode, the management device transmits a transition instruction to other currency processing devices located in the store the same as the currency processing device which has transitioned to the emergency mode, to transition the other currency processing devices to the emergency mode.

### BACKGROUND

### Technical Field

The disclosure relates to a currency processing system and a currency processing method.

### Description of Related Art

Some banknote processing machines have a robbery mode for withdrawing money to be handed over to a robber. For example, in Patent Literature 1 (WO 2020/066726), a currency processing system has a robbery mode for withdrawing currency to be handed over to a robber when the robber enters a financial institution, the currency processing system has a function of transitioning to the robbery mode via wireless communication from a mobile terminal such as a smartphone carried by a user (e.g. bank employee) to eliminate concerns that the robber will notice the bank employee that transitions the currency processing device to the robbery mode.

However, in the conventional currency processing system, the functionality of robbery mode can be performed within the system only and cannot be linked to other systems. For example, in a large commercial facility such as a shopping mall with many coin machines, it is difficult to appropriately change the operation modes of all machines according to the situation.

### PRIOR ART LITERATURE

### Patent Literature

[Patent Literature 1] International Patent Application Publication No. WO 2020/066726.

### SUMMARY

A currency processing system and a currency processing method which can timely transition the currency processing device that may be involved in the emergency event to an emergency mode, are provided in the disclosure, so as to reduce loss of currency due to the emergency event.

An embodiment of the disclosure provides a currency processing system including a plurality of currency processing devices which operate by selecting one of a normal mode and an emergency mode for responding to an emergency event as an operation mode, and a management device which manages the operation modes of the plurality of currency processing devices and information of a store where the plurality of currency processing devices are installed, in which, in response to the operation mode of at least one of the plurality of currency processing devices having transitioned to the emergency mode, the management device transmits a transition instruction to other currency processing devices located in the store the same as the currency processing device which has transitioned to the emergency mode, to transition the other currency processing devices to the emergency mode.

An embodiment of the disclosure provides a currency processing method for a currency processing system including a plurality of currency processing devices and a management device. The method includes steps of operating each of the plurality of currency processing devices by selecting one of a normal mode and an emergency mode for responding to an emergency event as an operation mode, and managing, by the management device, the operation modes of the plurality of currency processing devices and information of a store where the plurality of currency processing devices are installed, in which, in response to the operation mode of at least one of the plurality of currency processing devices having transitioned to the emergency mode, a transition instruction is transmitted to other currency processing devices located in the store the same as the currency processing device which has transitioned to the emergency mode, to transition the other currency processing device to the emergency mode.

Based on the above, in the currency processing system and the currency processing method of the disclosure, in response to the operation mode of any one currency processing device having transitioned to the emergency mode, other currency processing devices located in a same store, in an affiliated store, or in a same floor are forced to transition to the emergency mode, and information indicating the emergency event is transmitted to the user in charge of the currency processing devices, the customer, or the police, so as to reduce loss of currency due to the emergency event.

### BRIEF DESCRIPTION OF THE DRAWING

FIG. 1 is a diagram illustrating an example of a currency processing system according to an embodiment of the present invention.

FIG. 2 is a diagram illustrating an example of a block configuration of the mobile terminal la according to an embodiment of the present invention.

FIG. 3 is a diagram illustrating an example of a block configuration of the currency processing device 2a according to an embodiment of the present invention.

FIG. 4 is a diagram illustrating an example of a block configuration of the management device 4 according to an embodiment of the present invention.

FIG. 5 is a sequence diagram illustrating a currency processing method according to an embodiment of the present invention.

FIG. 6 is a sequence diagram illustrating a currency processing method according to an embodiment of the present invention.

FIG. 7 is a sequence diagram illustrating a currency processing method according to an embodiment of the present invention.

### DETAILED DESCRIPTION OF DISCLOSED EMBODIMENTS

Examples of the exemplary embodiments of the disclosure are illustrated in the drawings. If applicable, the same reference numerals in the drawings and the descriptions indicate the same or similar parts.

When a currency processing device transitions into an emergency mode, if the security of other currency processing devices is weak, there is a possibility that a robber could steal money from them. To prevent this, a mechanism is developed to send an emergency mode instruction to all currency processing devices in a store, currency processing devices in affiliated stores, or currency processing devices in a same floor through a management device.

To be specific, when a specific currency processing device in a store has transitioned to an emergency mode (or called “a robbery mode”) due to a robbery or other incident, an instruction to transition to the emergency mode is sent to all currency processing devices in the same store via a management device in the cloud, which reduces monetary loss to the entire store in an emergency event, even in an environment where coin machines are located in various places, such as a large commercial facility, and it is difficult to centrally manage currency processing devices with only a few superiors with management authority.

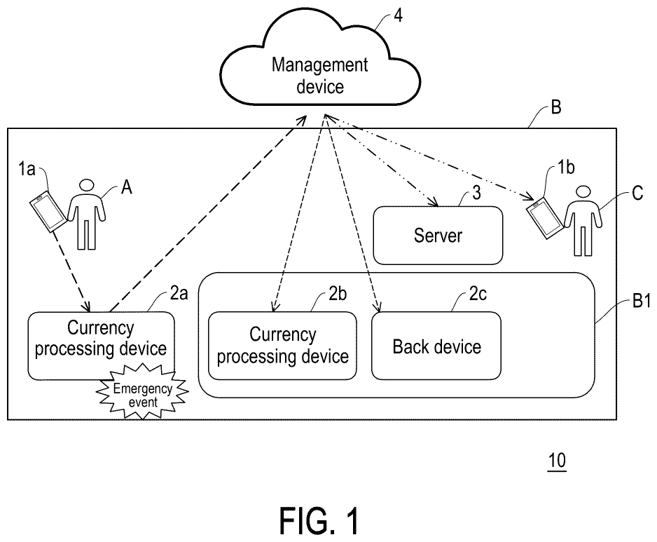

FIG. 1 is a diagram illustrating an example of a currency processing system according to an embodiment of the present invention. Referring to FIG. 1, the currency processing system 10 includes a mobile terminal 1a carried by a user A, a mobile terminal 1b carried by a user C, currency processing devices 2a and 2b, a back device 2c, a server 3, and a management server 4.

The mobile terminals la and 1b are terminal devices having a display and a wireless communication function. The mobile terminals la and 1b are, for example, mobile devices such as a smartphone, a tablet, or a wearable device. In some embodiments, the mobile terminals 1a and 1b may be terminal devices such as a laptop.

The mobile terminal la is owned by a user A who is an employee of a bank B. The user A is, for example, a senior manager (non-general clerk) who manages the bank B. The mobile terminal 1b is owned by a user C who is another employee of the bank B. The user B is, for example, a general clerk who performs deposit and withdrawal procedures at the counter.

The mobile terminal 1a performs wireless communication with the currency processing device 2a using, for example, Bluetooth (registered trademark) or Wi-Fi (registered trademark). Further, the mobile terminal la may perform wireless communication with the server 3 by Bluetooth, Wi-Fi, or the like.

The currency processing devices 2a and 2b are, for example, TCRs (Teller Cash Recycler). The TCR is a currency processing device that performs a deposit procedure and a withdrawal procedure. The currency processing devices 2a and 2b are installed, for example, in different places of the bank B. The present invention is also applicable to a case where the currency processing devices 2a and 2b are currency processing devices other than TCR, for example, ATM (Automatic Teller Machine). Depending on the type of currency processing device, the currency processing device may be installed in a lobby of the bank B. For example, as shown in FIG. 1, the currency processing device 2 a is installed in a lobby of the bank B while the currency processing device 2b is installed in a counter B1 of the bank B.

The currency processing devices 2a and 2b operate in one of a normal mode and an emergency mode. The normal mode is a mode for performing a deposit procedure and a withdrawal procedure as instructed by an operator such as a banker or a customer. The emergency mode is an operation mode used when an emergency event such as a robbery occurs. In the emergency mode, the currency processing devices 2a and 2b operate in the same manner as in the normal mode, but when the amount of money to be withdrawn from the withdrawal port reaches a predetermined amount, the currency processing devices 2a and 2b are operated in a mode in which the remaining amount of the banknotes remaining in the device is displayed as “0”. The emergency mode is a mode used when a robbery occurs, and may be referred to as a robbery mode.

The back device 2c is, for example, another TCR or currency processing device having a higher security level, and is configured to deposit the currency collected by a clerk from the currency processing devices including the currency processing devices 2a and 2b. In the present embodiment, the back device 2c and the currency processing device 2b are installed inside the counter B1 such that the clerk may conveniently and safely deposit currency collected from the currency processing device 2b to the back device 2c.

In some embodiments, the operation mode of the currency processing device 2a is transitioned between the normal mode and the emergency mode according to an instruction transmitted from the mobile terminal la possessed by the user A. In some embodiments, the operation mode of the currency processing device 2a is transitioned by selecting one of the normal mode and the emergency mode by the user A (e.g. senior manager) who performs the management work of the bank B and the like.

For example, assuming that the currency processing device 2a is operated in the normal mode, when the mobile terminal la receives an operation of transitioning the operation mode to the emergency mode from the user A, it transmits a transition instruction to the currency processing device 2a for instructing the currency processing device 2a to transition to the emergency mode by wireless communication. That is, the currency processing device 2a that receives the transition instruction will transition the operation mode from the normal mode to the emergency mode.

In some embodiments, the operation mode of the currency processing device 2a is transitioned between the normal mode and the emergency mode by the server 3 that is configured to monitor the emergency event occurred in the bank B. The server 3 may be connected to a camera (not shown) that photographs, for example, the lobby, the counter B1, or the inside of the counter B1 of the bank B, and photographs the person who operates the currency processing device 2a. The camera transmits image data of the captured images to the server 3.

The server 3 is, for example, a device that manages the security of the bank B. For example, the server 3 analyzes the image data of the camera by cognitive computing, and determines (detects) the occurrence of a robbery, the position of the robbery, and the like. The cognitive computing refers to a system that performs inference and learning by itself.

Assuming that an emergency event (e.g. a robbery) has occurred in the bank B, as shown in FIG. 1, and the emergency event is located in front of the currency processing device 2a, the server 3 may analyze the image data of the camera and determine the occurrence and the position of the emergency event. For example, the server 3 determines that the emergency event is located in front of the currency processing device 2a, and then transmits a transition instruction to the currency processing device 2a for instructing the currency processing device 2a to transition to the emergency mode by wireless communication.

In some embodiments, the server 3 may transmits position information indicating the position of the emergency event to the mobile terminal 1a. The mobile terminal la receives the position information transmitted from the server 3, and displays the position of the emergency event on the display of the mobile terminal la based on the received position information. For example, the mobile terminal la visually displays a plane view inside the bank B and the position of the emergency event on the display of the mobile terminal la. Thus, the user A having the mobile terminal la can easily recognize the occurrence and position of the emergency event. When the user A recognizes the occurrence and position of the emergency event, the user A may use the mobile terminal la to transition the operation mode of the currency processing device 2a to the emergency mode by transmitting a transition instruction to the currency processing device 2a. When the mobile terminal la receives, from the user A, an operation of transitioning the money processing device 2a to the emergency mode, it transmits a transition instruction to the currency processing device 2a so as to transition the operation mode of the currency processing device 2a to the emergency mode. When receiving the instruction to transition to the emergency mode from the mobile terminal 1a, the currency processing device 2a transitions the operation mode from the normal mode to the emergency mode.

Thus, the user A can remotely operate the currency processing device 2a using the mobile terminal 1a from a position away from the emergency event without directly operating the currency processing device 2a. The operation mode can be easily transitioned to the emergency mode.

When transitioning to the emergency mode, the currency processing device 2a may transmit information indicating the operation mode of the currency processing device 2a has transitioned to the emergency mode to the management server 3. In some embodiments, when instructing the currency processing device 2a to transition to the emergency mode, the mobile terminal 1a may transmit information indicating the operation mode of the currency processing device 2a has transitioned to the emergency mode to the management server 3.

The management device 3 is, for example, a personal computer, a fileserver, a webserver, a database server, a workstation, or other devices situated in the cloud with computing functions. The management device 3 includes a processor for performing management of operation modes of a plurality of currency processing devices (including the currency processing devices 2a and 2b) and includes a storage device for storing information in which the plurality of currency processing devices are located.

When receiving the information indicating the operation mode of the currency processing device 2a has transitioned to the emergency mode, the management device 3 may search for a store in which the currency processing device 2a is located and search for other currency processing devices located in a store the same as the currency processing device 2a. When the currency processing device 2b is found to be located in a store the same as the currency processing device 2a, the management device 3 transmits a transition instruction to the currency processing device 2b, so as to transition the currency processing device 2b to the emergency mode.

In some embodiments, in addition to transmitting the transition instruction to the currency processing device 2b, the management device 3 may also transmit instruction to the back device 2c and the server 3 located in the store the same as the currency processing device 2a, so as to transition the back device 2c and the server 3 to the emergency mode. Further, the management device 3 may also transmit a message indicating the currency processing device 2b has transitioned to the emergency mode to the mobile terminal 1b carried by the user C who deposits currency into or withdraws currency from the currency processing device 2b.

Although the currency processing system 10 is applied to the currency processing devices in bank B in FIG. 1, it is not limited to this. The currency processing system 10 may be applied to the currency processing devices in various locations such as a retail store, a shopping mall, or a department store.

Although the currency processing devices 2a and 2b perform the currency deposit and withdrawal procedures, the present invention is not limited to this. The currency processing devices 2a and 2b may support at least one of the currency deposit and withdrawal procedures.

The number of the mobile terminals la and 1b is not limited to the example of FIG. 1, and may be two or more. Further, the number of currency processing devices 2a and 2b is also not limited to the example of FIG. 1, and may be four or less, or six or more. The currency processed by the currency processing devices 2a and 2b may be bills, coins or both, which is not limited in the present embodiment.

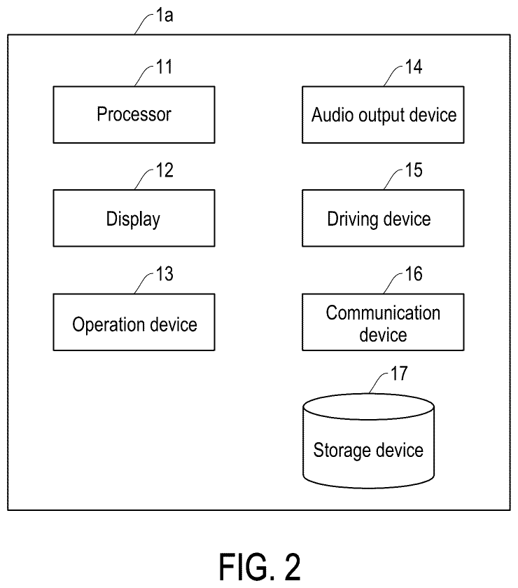

FIG. 2 is a diagram illustrating an example of a block configuration of the mobile terminal 1a according to an embodiment of the present invention. As illustrated in FIG. 2, the mobile terminal 1a includes a processor 11, a display 12, an operation device 13, an audio output device 14, a driving device 15, a communication device 16, and a storage device 17.

The processor 11 controls the entire mobile terminal la. The processor 11 may be configured by, for example, a CPU (Central Processing Unit).

The display 12 displays an image based on the digital image data output from the processor 11. The display 12 is, for example, a liquid crystal display (LCD).

The operation device 13 receives, for example, an operation of the user A who is the owner of the mobile terminal 1a. The operation device 13 outputs information corresponding to the received operation to the processor 11. The operation device 13 is, for example, a touch panel superimposed on the display 12, or a key input device or the like.

The audio output device 14 outputs audio based on the digital audio data output from the processor 11. The audio output device 14 is, for example, a speaker.

The driving device 15 is, for example, a motor. The driving device 15 causes the mobile terminal 1a to vibrate under the control of the processor 11, for example.

The communication device 16 communicates with the currency processing device 2a by wireless communication such as Bluetooth or Wi-Fi. The communication device 16 communicates with the server 3 by wireless communication such as Bluetooth or Wi-Fi.

The storage device 17 stores a program to be loaded by the processor 11 for operating the mobile terminal 1a. The storage device 17 stores data for the processor 11 to perform calculation processing or data for controlling each device. The storage device 17 may include a device such as a random access memory (RAM), a read only memory (ROM), a flash memory, or a hard disk drive (HDD).

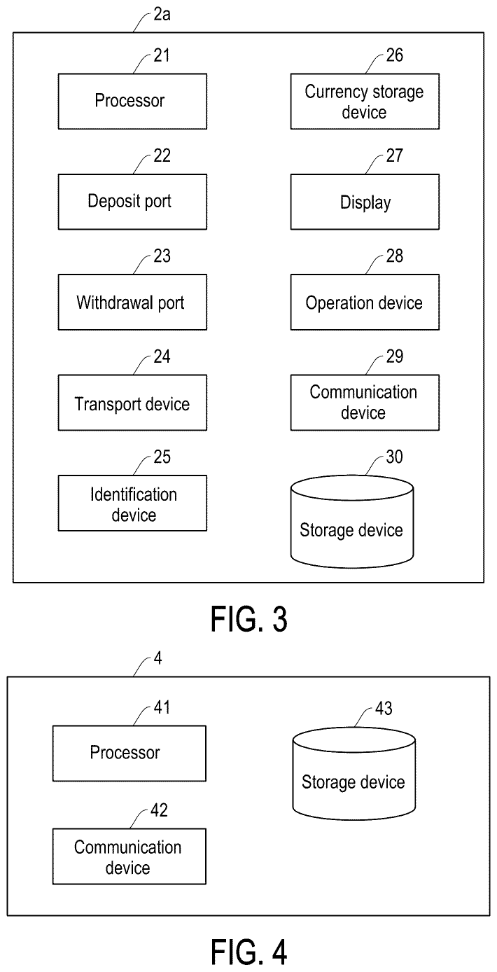

FIG. 3 is a diagram illustrating an example of a block configuration of the currency processing device 2a according to an embodiment of the present invention. As shown in FIG. 3, the currency processing device 2a includes a processor 21, a deposit port 22, a withdrawal port 23, a transport device 24, an identification device 25, a currency storage device 26, a display 27, and an operation device 28, a communication device 29, and a storage device 30.

The processor 21 controls the entire currency processing apparatus 2a. The processor may be configured by, for example, a CPU.

The deposit port 22 is configured for a user to insert currency. The deposit port 22 is configured to feed out the inserted currency to the transport device 24.

The currency transported by the transport device 24 is accumulated in the withdrawal port 23. The user or the customer can take out the currency accumulated in the withdrawal port 23 from the withdrawal port 23.

The transport device 24 transports the currency deposited in the deposit port 22 to the storage device 30 based on the control of the processor 21. Further, the transport device 24 transports the currency fed from the currency storage device 26 to the withdrawal port 23 under the control of the processor 21.

The identification device 25 is provided around the transport device 24. The identification device 25 includes various sensors (not shown), and identifies a denomination, true/false, front/back, fitness, new/old, etc. of the currency conveyed by the transport device 24. The currency transported by the transport device 24 is transported to the currency storage device 26 corresponding to the denomination of the currency, for example, according to the identification result of the identification device 25.

The currency storage device 26 is provided in the currency processing device 2a, for example, corresponding to each denomination of currency. The currency storage device 26 stores the currency transported by the transport device 24. The currency storage device 26 feeds out the stored currency to the transport device 24 based on the control of the processor 21.

The display 27 displays an image based on the digital image data output from the processor 21. The display 27 is, for example, a liquid crystal display (LCD).

The operation device 28 receives, for example, an operation of a user or a customer. The operation device 28 outputs information corresponding to the received operation to the processor 21. The operation device 28 is, for example, a touch panel superimposed on the display 27, a key input device or the like.

The communication device 29 communicates with the mobile terminals la and 1b by wireless communication such as Bluetooth or Wi-Fi.

The storage device 30 stores a program to be loaded by the processor 21 for operating the currency processing device 2a. The storage device 30 stores data for the processor 21 to perform calculation processing or data for controlling each device. The storage device 30 may include a device such as a RAM, a ROM, a flash memory, or an HDD.

In FIG. 3, the example of the block configuration of the currency processing device 2a has been described, but the currency processing device 2b also has the same blocks as the currency processing device 2a.

FIG. 4 is a diagram illustrating an example of a block configuration of the management device 4 according to an embodiment of the present invention. As illustrated in FIG. 4, the management device 4 includes a processor 41, a communication device 42, and a storage device 43.

The processor 41 controls the entire management device 4. The processor 41 may be configured by, for example, a CPU.

The communication device 42 communicates with the mobile terminals la and 1b by wireless communication such as Bluetooth or Wi-Fi, for example. The communication device 42 communicates with the currency processing devices 2a and 2b by wireless communication such as Bluetooth or Wi-Fi or by wired communication using a LAN (Local Area Network) cable.

The storage device 43 stores a program to be loaded by the processor 41 for operating the management device 4. The storage device 43 stores data for the processor 41 to perform calculation processing or data for controlling each device. The storage device 43 may be a device such as a RAM, a ROM, a flash memory, or an HDD.

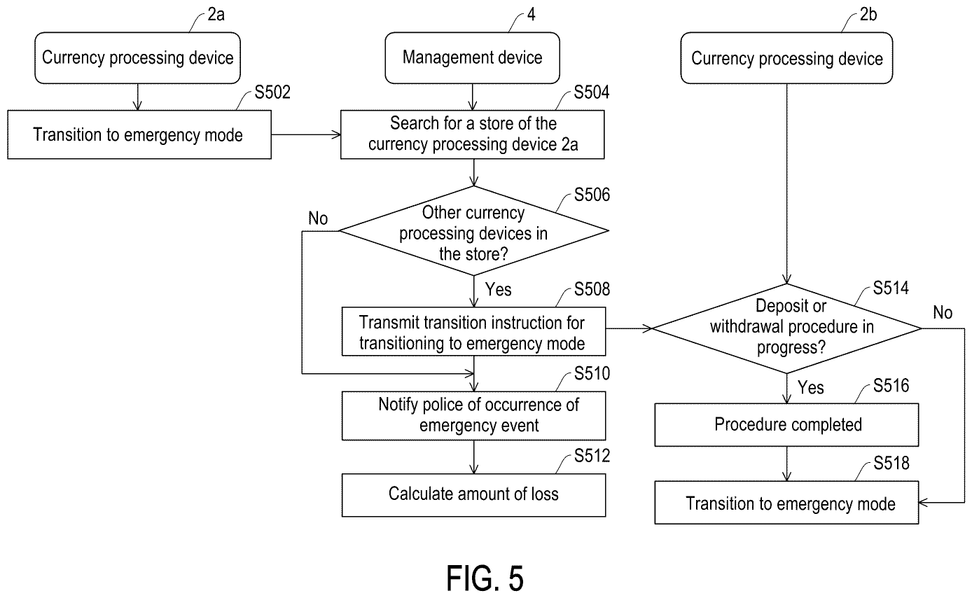

FIG. 5 is a sequence diagram illustrating a currency processing method according to an embodiment of the present invention. Referring to FIG. 5, the method provided by this embodiment is adapted for the currency processing system 10 in FIG. 1, and steps of the method are described in detail below with reference to the currency processing devices 2a and 2b and the management device 4 in the currency processing system 10.

In step S502, the currency processing device 2a transitions to the emergency mode. As illustrated above, the currency processing device 2a may transition the operation mode from the normal mode to the emergency mode in response to receiving a transition instruction transmitted from a mobile terminal 1a or a server 3.

To be specific, when the mobile terminal la receives an operation of transitioning the operation mode to the emergency mode from the user A, it transmits the transition instruction to the currency processing device 2a for instructing the currency processing device 2a to transition to the emergency mode by wireless communication.

In some embodiments, when the server 3 determines that the emergency event is located in front of the currency processing device 2a based on the image data of the camera, it transmits the transition instruction to the currency processing device 2b for instructing the currency processing device 2a to transition to the emergency mode by wireless communication.

In step S504, the management device 4 searches for a store of the currency processing device 2a based on store information in which the plurality of currency processing devices are installed stored in the storage device 43. The management device 4 may acquire information indicating the operation mode of the currency processing device 2a has transitioned to the emergency mode from the currency processing device 2a or the mobile terminal la which instructs the currency processing device 2a to transition to the emergency mode. In some embodiments, the management device 4 may periodically monitor the operation of the currency processing device 2a, so as to learn the transition of the operation of the currency processing device 2a.

In step S506, the management device 4 determines whether there are other currency processing devices located in the store the same as the currency processing device 2a which has transitioned to the emergency mode.

If there are other currency processing devices located in the store, in step S508, the management device 4 transmits a transition instruction for transitioning to the emergency mode to the other currency processing devices (e.g. the currency processing device 2b).

If there is no currency processing device located in the store, the management device 4 notifies the police of occurrence of the emergency event in step S510, and calculates an amount of loss due to the emergency event in step S512.

In some embodiments, in response to the operation mode of the at least one of the plurality of currency processing devices has transitioned to the emergency mode, the management device 4 may transmit a message indicating the currency processing device has transitioned to the emergency mode to a mobile terminal carried by a user who deposits currency into or withdraws currency from the currency processing device, so as to warn the user that the emergency event (e.g. robbery) has occurred. Since the transition to the emergency mode is notified to employees and managers' smartphones, the emergency information can be shared quickly within the store.

In step S514, when receiving the transition instruction transmitted in step S508 from the management device 4, the currency processing device 2b determines whether there is a deposit or withdrawal procedure in progress.

If there is a deposit or withdrawal procedure in progress, the currency processing device 2b holds the transition instruction until the deposit or withdrawal procedure is completed in step S516 and then transitions to the emergency mode in step S518.

On the other hand, if there is no deposit or withdrawal procedure in progress, the currency processing device 2b directly transitions to the emergency mode in step S518. Since the deposit or withdrawal procedure is completed before transitioning to the emergency mode, the amount of currency stolen by robbers in the emergency mode (e.g. robbery mode) can be reduced. In some embodiments, when there is a deposit or withdrawal procedure in progress, the currency processing device 2b may continue the deposit procedure while stopping the withdrawal procedure before transitioning to the emergency mode, so as to reduce the amount of currency lost in the emergency event.

In some embodiments, when the management device 4 determines there are other currency processing devices located in the store in step S506, the management device 4 may determine whether there is a deposit or withdrawal procedure in progress in each of the other currency processing devices by monitoring the operation of the other currency processing devices. If there is a deposit or withdrawal procedure in progress, the management device 4 holds the transition instruction until the deposit or withdrawal procedure is completed, and then transmits the transition instruction for transitioning to the emergency mode to the other currency processing devices, so as to instruct the other currency processing devices to transition to the emergency mode.

In some embodiments, the management device 4 further determines whether to transport currency to the store in order to replenish currency in the currency processing device, and whether to transport currency from the store in order to collect currency from the currency processing device. As a result, changes in the amount of currency in a robbery can be quickly acquired and reported to the policy such that crime prevention capabilities can be improved.

Based on the above, since all the currency processing devices in the store are instructed to transition to the emergency mode in response to any one of them having transitioned to the emergency mode, loss of currency due to the emergency event may be reduced.

In addition to instruct the currency processing devices in a same store, the transition instruction may be further transmitted to the currency processing devices in nearby affiliated stores or the currency processing devices in the same floor, and information indicating the occurrence and location of the emergency event may be further transmitted to the police or associated personals, so as to reduce loss of currency.

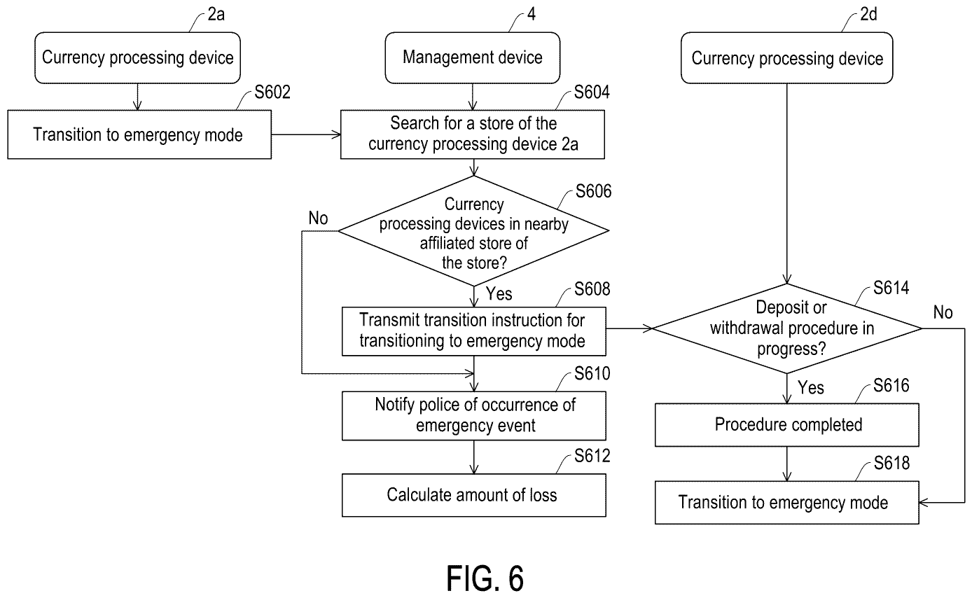

FIG. 6 is a sequence diagram illustrating a currency processing method according to an embodiment of the present invention. Referring to FIG. 6, the method provided by this embodiment is adapted for the currency processing system 10 in FIG. 1, and steps of the method are described in detail below with reference to the currency processing device 2a, a currency processing device 2d (not shown), and the management device 4 in the currency processing system 10.

In step S602, the currency processing device 2a transitions to the emergency mode. The currency processing device 2a may transition the operation mode from the normal mode to the emergency mode in response to receiving a transition instruction transmitted from a mobile terminal 1a or a server 3, and the present embodiment is not limited thereto.

In step S604, the management device 4 searches for a store of the currency processing device 2a based on the information in which the plurality of currency processing devices are located stored in the storage device 43.

In step S606, the management device 4 determines whether there are currency processing devices in a nearby affiliated store of the store. The currency processing devices in nearby affiliated store are, for example, ATMs or coin dispensers in nearby commercial facility.

If there are currency processing devices in the nearby affiliated store, in step S608, the management device 4 transmits a transition instruction for transitioning to the emergency mode to the currency processing devices (e.g. the currency processing device 2d).

If there is no currency processing device located in the nearby affiliated store, in step S610, the management device 4 notifies the police of occurrence of the emergency event, and in step S612, the management device 4 calculates an amount of loss due to the emergency event.

In step S614, when receiving the transition instruction transmitted in step S608 from the management device 4, the currency processing device 2d determines whether there is a deposit or withdrawal procedure in progress.

If there is a deposit or withdrawal procedure in progress, the currency processing device 2d holds the transition instruction until the deposit or withdrawal procedure is completed in step S616 and then transitions to the emergency mode in step S618.

On the other hand, if there is no deposit or withdrawal procedure in progress, the currency processing device 2d directly transitions to the emergency mode in step S618. Since the deposit or withdrawal procedure is completed before transitioning to the emergency mode, the amount of currency stolen by robbers in the emergency mode (e.g. robbery mode) can be reduced.

In some embodiments, when the management device 4 determines there is a currency processing device in the nearby affiliated store in step S606, the management device 4 may determine whether there is a deposit or withdrawal procedure in progress in each of the currency processing devices by monitoring the operation of the currency processing devices. If there is a deposit or withdrawal procedure in progress, the management device 4 holds the transition instruction until the deposit or withdrawal procedure is completed, and then transmits the transition instruction for transitioning to the emergency mode to the currency processing devices, so as to instruct the currency processing devices to transition to the emergency mode.

Based on the above, by allowing affiliated stores to share information about emergency events such as robberies, crime prevention capabilities against group robbery for a same chain store can be improved.

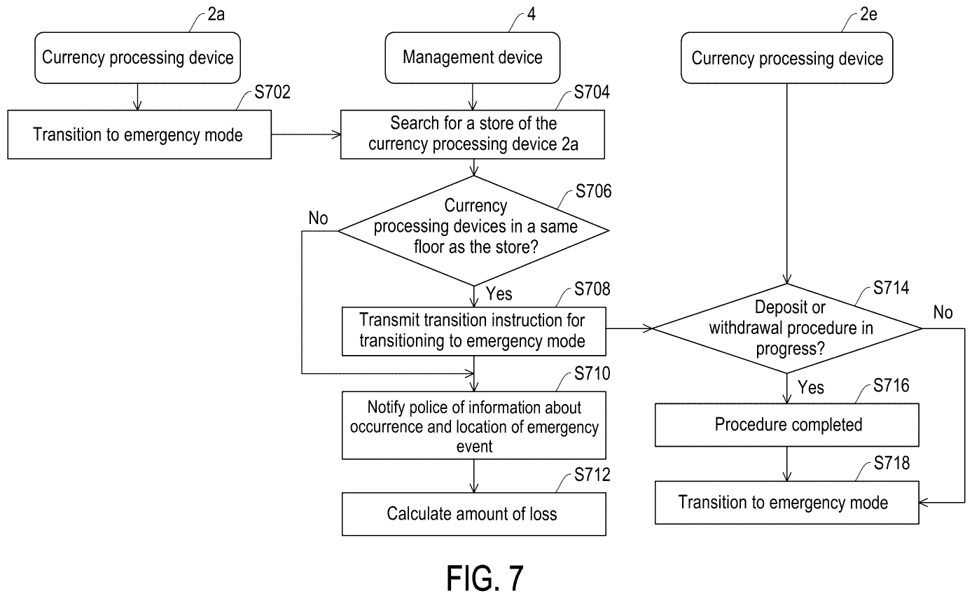

FIG. 7 is a sequence diagram illustrating a currency processing method according to an embodiment of the present invention. Referring to FIG. 7, the method provided by this embodiment is adapted for the currency processing system 10 in FIG. 1, and steps of the method are described in detail below with reference to the currency processing device 2a, a currency processing device 2e (not shown), and the management device 4 in the currency processing system 10.

In step S702, the currency processing device 2a transitions to the emergency mode. The currency processing device 2a may transition the operation mode from the normal mode to the emergency mode in response to receiving a transition instruction transmitted from a mobile terminal la or a server 3, and the present embodiment is not limited thereto.

In step S704, the management device 4 searches for a store of the currency processing device 2a based on the information in which the plurality of currency processing devices are located stored in the storage device 43.

In step S706, the management device 4 determines whether there are currency processing devices in the same floor as the store.

If there are currency processing devices in the same floor as the store, in step S708, the management device 4 transmits a transition instruction for transitioning to the emergency mode to the currency processing devices (e.g. the currency processing device 2e).

If there is no currency processing device located in the same floor as the store, in step S710, the management device 4 notifies the police of occurrence and location of the emergency event, and in step S712, the management device 4 calculates an amount of loss due to the emergency event. In some embodiments, the management device 4 may notifies the police of further details of the emergency event including the building.

In step S714, when receiving the transition instruction transmitted in step S708 from the management device 4, the currency processing device 2e determines whether there is a deposit or withdrawal procedure in progress.

If there is a deposit or withdrawal procedure in progress, the currency processing device 2e holds the transition instruction until the deposit or withdrawal procedure is completed in step S716 and then transitions to the emergency mode in step S718.

On the other hand, if there is no deposit or withdrawal procedure in progress, the currency processing device 2e directly transitions to the emergency mode in step S718. Since the deposit or withdrawal procedure is completed before transitioning to the emergency mode, the amount of currency stolen by robbers in the emergency mode (e.g. robbery mode) can be reduced.

In some embodiments, when the management device 4 determines there is a currency processing device in the nearby affiliated store in step S606, the management device 4 may determine whether there is a deposit or withdrawal procedure in progress in each of the currency processing devices by monitoring the operation of the currency processing devices. If there is a deposit or withdrawal procedure in progress, the management device 4 holds the transition instruction until the deposit or withdrawal procedure is completed, and then transmits the transition instruction for transitioning to the emergency mode to the currency processing devices, so as to instruct the currency processing devices to transition to the emergency mode.

Based on the above, since the currency processing devices in the nearby affiliated store are instructed to transition to the emergency mode in response to any one of them having transitioned to the emergency mode, loss of currency due to the emergency event may be reduced.

To sum up, in the currency processing system and the currency processing method of the disclosure, in response to the operation mode of any one currency processing device having transitioned to the emergency mode, other currency processing devices located in a same store, in an affiliated store, or in a same floor are forced to transition to the emergency mode, and information indicating the emergency event is transmitted to the user in charge of the currency processing devices, the customer, or the police. As a result, loss of currency due to the emergency event can be reduced and crime prevention capabilities of the currency processing system can be improved.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

1. A currency processing system comprising:
a plurality of currency processing devices which operate by selecting one of a normal mode and an emergency mode for responding to an emergency event as an operation mode, wherein the plurality of currency processing devices comprise a first currency processing device and a second currency processing device; and
a management device which manages the operation mode of the plurality of currency processing devices and information of a store where the plurality of currency processing devices are installed, wherein
in response to the operation mode of the first currency processing device having transitioned to the emergency mode, the management device transmits a transition instruction to the second currency processing device located, in the store where the plurality of currency processing devices are installed to transition the operation mode of the second currency processing device to the emergency mode.

2. The currency processing system as claimed in claim 1, wherein
in response to the operation mode of the first currency processing device having transitioned to the emergency mode, the management device transmits a message indicating the operation mode of the first currency processing device has transitioned to the emergency mode to a mobile terminal carried by a user who deposits currency into or withdraws currency from one of the plurality of currency processing devices.

3. The currency processing system as claimed in claim 1, wherein in response to the second currency processing device performing a deposit or withdrawal process, the management device transitions the operation mode of the second currency processing device to the emergency mode after the deposit or withdrawal process is completed.

4. The currency processing system as claimed in claim 1, wherein
the management device determines whether to transport currency to the store in order to replenish currency in the plurality of currency processing devices, and whether to transport currency from the store in order to collect currency from the plurality of currency processing devices.

5. The currency processing system as claimed in claim 1, wherein
in response to the operation mode of the first currency processing device having transitioned to the emergency mode, the management device notifies mobile terminals carried by users in at least one affiliated store of the store where the plurality of currency processing devices are installed.

6. The currency processing system as claimed in claim 1, wherein
in response to the operation mode of the first currency processing device being transitioned to the emergency mode, the management device notifies at least one third currency processing device in at least one affiliated store of the store where the plurality of currency processing devices are installed.

7. The currency processing system as claimed in claim 1, further comprising:
a mobile terminal which transmits a transition instruction for transitioning the operation mode to the emergency mode to the plurality of currency processing devices by wired communication or wireless communication.

8. A currency processing method for a currency processing system including a plurality of currency processing devices and a management device, the method comprising:
operating each of the plurality of currency processing devices by selecting one of a normal mode and an emergency mode for responding to an emergency event as an operation mode, wherein the plurality of currency processing devices comprise a first currency processing device and a second currency processing device; and
managing, by the management device, the operation mode of the plurality of currency processing devices and information of a store where the plurality of currency processing devices are installed, comprising:
in response to the operation mode of the first currency processing device having transitioned to the emergency mode, transmitting a transition instruction to the second currency processing device located in the store where the plurality of currency processing devices are installed, to transition the operation mode of the second currency processing device to the emergency mode.

9. The currency processing method as claimed in claim 8, wherein managing, by the management device, the operation mode of the plurality of currency processing devices and the information of the store in which the plurality of currency processing devices are installed further comprises:
in response to the operation mode of the of first currency processing device having transitioned to the emergency mode, transmitting a message indicating the operation mode of the first currency processing device has transitioned to the emergency mode to a mobile terminal carried by a user who deposits currency into or withdraws currency from one of the plurality of currency processing devices.

10. The currency processing method as claimed in claim 8, wherein managing, by the management device, the operation mode of the plurality of currency processing devices and the information of the store in which the plurality of currency processing devices are installed further comprises:
in response to the second currency processing device performing a deposit or withdrawal process, transitioning the operation mode of the second currency processing device to the emergency mode after the deposit or withdrawal process is completed.

11. The currency processing method as claimed in claim 8, wherein managing, by the management device, the operation mode of the plurality of currency processing devices and the information of the store in which the plurality of currency processing devices are installed further comprises:
determining whether to transport currency to the store in order to replenish currency in the plurality of currency processing devices, and whether to transport currency from the store in order to collect currency from the plurality of currency processing devices.

12. The currency processing method as claimed in claim 8, wherein managing, by the management device, the operation modes of the plurality of currency processing devices and the information of the store in which the plurality of currency processing devices are installed further comprises:
in response to the operation mode of the first currency processing device having transitioned to the emergency mode, notifying mobile terminals carried by users in at least one affiliated store of the store where the plurality of currency processing devices are installed.

13. The currency processing method as claimed in claim 8, wherein managing, by the management device, the operation mode of the plurality of currency processing devices and the information of the store in which the plurality of currency processing devices are installed further comprises:
in response to the operation mode of the first currency processing device having transitioned to the emergency mode, notifying, by the management device, at least one third currency processing device in at least one affiliated store of the store where the plurality of currency processing devices are installed.

14. The currency processing method as claimed in claim 8, further comprising:
transmitting, by a mobile terminal, a transition instruction for transitioning the operation mode to the emergency mode to the plurality of currency processing devices by wired communication or wireless communication.
